(19) United States
(12) Patent Application Publication
(10) Pub. No.: US 2010/0323248 A1
(43) Pub. Date: Dec. 23, 2010

(54) STRUCTURES HAVING ONE OR MORE SUPER-HYDROPHOBIC SURFACES AND METHODS OF FORMING SAME

(75) Inventors: MANOHAR S. SOHAL, IDAHO FALLS, ID (US); KEVIN M. MCHUGH, Idaho Falls, ID (US)

Correspondence Address: TraskBritt / Battelle Energy Alliance, LLC, PO Box 2550, Salt Lake City, UT, 84110, US

(73) Assignee: BATTELLE ENERGY ALLIANCE, LLC, IDAHO FALLS, ID (US)

(21) Appl. No.: 12/486,318

(22) Filed: Jun. 17, 2009

(51) Int. Cl. H01M 8/00

(52) U.S. Cl. 429/400; 427/448; 427/115; 428/687; 429/535

(57) ABSTRACT

Methods of forming hydrophobic surfaces or structures include spraying droplets of a material onto features on a surface of a substrate and at least partially coating the features with a material formed from the droplets. Methods of forming fuel or electrolytic cells include forming a plurality of features in a surface of a conductive plate within a channel therein, and configuring the surface of the conductive plate within the channel to be hydrophobic. Additional methods of forming fuel or electrolytic cells include forming a substrate having a surface comprising at least one channel therein, forming a plurality of features on a surface of the substrate within the at least one channel, spraying droplets of a material onto the substrate, and at least partially coating the features with a metal layer formed from the droplets. Hydrophobic structures such as, for example, conductive electrodes for fuel and electrolytic cells are fabricated using such methods.

### GOVERNMENT RIGHTS

This invention was made with support under Contract No. DE-AC07-051D14517 awarded by the United States Department of Energy. The government has certain rights in the invention.

### TECHNICAL FIELD

Embodiments of the present invention relate to structures and devices that include one or more super-hydrophobic surfaces, and to methods of fabricating such structures and devices. Additional embodiments of the present invention relate to conductive electrodes for fuel cells (e.g., polymer electrolytic membrane (PEM) fuel cells) that include one or more super-hydrophobic channel surfaces, and to methods of fabricating such conductive electrodes and fuel cells.

### BACKGROUND

Hydrophobic surfaces are surfaces that are repulsive to water and other polar liquids and substances. In contrast, hydrophilic surfaces are surfaces that are attractive to water and other polar liquids and substances. The hydrophobicity or hydrophilicity of a surface, which is a quantitative characterization of the degree to which a surface repels or attracts a liquid (e.g., water), respectively, may be measured by using a number of techniques. Measuring the angle of contact or “contact angle” between a droplet of liquid and a solid surface on which the droplet of liquid is supported is one such technique. The contact angle is defined as the angle between the liquid-solid interface and a plane tangent to the liquid-gas interface at a point where the droplet meets the solid surface. Surfaces that are hydrophobic will exhibit a contact angle of greater than ninety degrees) (90°, whereas surfaces that are hydrophilic (i.e., attractive to water and other polar liquids and substances) will exhibit a contact angle of less than ninety degrees) (90°. Surfaces that are super-hydrophobic (also referred to as “ultra-hydrophobic”) exhibit a contact angle of about one hundred thirty-five degrees) (135° or more. American Society for Testing and Materials (ASTM) Test Method D7334-08, which is entitled Standard Practice for Surface Wettabiltiy of Coatings, Substrates and Pigments by Advancing Contact Angle Measurement, is a standardized contact angle measurement method that may be used to characterize the hydrophobicity or hydrophilicity of a surface, and is incorporated herein in its entirety by this reference. It is known that the hydrophobicity of a surface is at least partially a function of both the chemical composition of the solid surface, as well as the physical topography (roughness) of the surface. For example, a surface comprising protrusions having an average diameter less than about one hundred microns (100 μm) and separated from one another by an average distance of less than about one hundred microns (100 μm) may exhibit a significantly greater hydrophobicity compared to a flat surface of the same material.

The performance of many devices that, during operation, are in physical contact with water (or another polar liquid) may be controlled or manipulated by increasing the hydrophobicity of surfaces of the device that are in contact with the water during operation. For example, a PEM fuel cell may include one or more conductive electrode plates having fluid flow channels therein that may be in contact with water during operation of the fuel cell to generate electricity.

Fuel cells are electrochemical devices that convert the chemical energy of a reaction directly into electrical energy. The basic physical structure of a fuel cell includes a porous anode, a porous cathode, and an electrolyte layer disposed between the porous anode and the porous cathode. The electrolyte layer is in immediate physical contact with both the anode and the cathode. A basic schematic diagram of a fuel cell is shown in FIG. 1. As illustrated therein, in a conventional fuel cell, fuel is fed continuously to the porous anode and an oxidant is fed continuously to the porous cathode. Channels formed in conductive electrode plates are often used to feed the fuel to the porous anode and to feed the oxidant to the porous cathode.

Various fuels and oxidants are known in the art. As one example, the fuel may be or include hydrogen gas and the oxidant may be or include oxygen (which may be supplied in air). In such a fuel cell, the reaction occurring at the anode is shown in Reaction [1] below, the reaction occurring at the cathode is shown in Reaction [2] below, and the overall reaction is shown in Reaction [3] below.

H₂+O²⁻→H₂O+2e⁻ [1]

½O₂+2e⁻→O²⁻ [2]

H₂+½O₂→H₂O [3]

The negatively charged oxygen ions generated by the cathode migrate through the electrolyte layer from the cathode to the anode, while the electrons travel through the external circuit from the anode to the cathode.

A background description of fuel cells can be found in Chapters 1 and 2 of the Fuel Cell Handbook, Seventh Edition, which was prepared by EG&G Technical Services, Inc. for the United States Department of Energy and published in November of 2004, the entire contents of which chapters are incorporated herein in their entirety by this reference.

One particular type of fuel cell is the polymer electrolyte membrane (PEM) fuel cell (sometimes referred to as a “proton exchange membrane” fuel cell). In PEM fuel cells, the electrolyte layer comprises a polymer material. PEM fuel cells may be operated at temperatures that are relatively lower than the operating temperatures of other types of fuel cells such as, for example, solid oxide fuel cells.

During operation of PEM fuel cells, the H₂ gas is supplied to the anode through flow channels formed in a conductive anode plate, and O₂ gas and/or air is supplied to the cathode through flow channels formed in a conductive cathode plate. These conductive electrodes or “plates” are used to maintain proper hydration of the polymer electrolyte membrane, to remove excess water from the fuel cell, to conduct electrical current through the fuel cell, to cool the fuel cell, and to separate individual fuel cells in a stack of fuel cells within multi-cell devices.

The state of the art of conductive electrode designs for fuel cells has been hampered by the inability to manufacture fine-scale flow channels and features in the conductive electrodes in a cost-effective manner for large-volume production. The methods currently used to fabricate conductive electrodes for fuel cells include direct machining of the electrodes or direct machining of tooling (molds and dies) that is used to produce the electrodes by forging, stamping, die casting, injection molding, compression molding, etc. Other techniques such as selective laser sintering, fused deposition modeling, direct metal deposition, and other additive build-up methods offer unique manufacturing capabilities but, often, undesirably create steps in side walls, a rough exposed surface and due to the high cost, generally are not practical for high-volume production. Unfortunately, conventional machining of bipolar plates or the tooling (molds and dies) needed to form plates is very expensive, time consuming, and is limited to relatively “coarse” flow channel designs. Conventional machining techniques generally require that the flow channel widths be greater than about one millimeter (1 mm), that relatively large solid wall thicknesses be provided between adjacent flow channels, and that the flow channels have simple-shaped geometries.

Fuel cells are closely related to electrolytic cells, and many fuel cells can be operated as electrolytic cells for performing electrolysis of a liquid by replacing the external circuit associated with the fuel cell with an electrical power source (such as, for example, a battery), providing a liquid to be electrolyzed in contact with the anode and the cathode, and applying a voltage between the anode and the cathode using the external power source. For example, water may be provided in contact with the anode and the cathode, and a voltage may be applied between the anode and the cathode, which may cause oxygen gas to be formed at the anode and hydrogen gas to be formed at the cathode.

In view of the above, there is a need in the art for fabrication technologies that may be used to manufacture and test novel flow channel design parameters such as channel width, flow channel shape and geometry, flow channel surface topology, and flow channel surface substructure in order to enhance the performance of fluid flow through flow channels in conductive electrodes in fuel cells and electrolytic cells. More broadly, there is a need in the art for fabrication technologies that may be used to form surfaces and structures having fine-scale (e.g., less than about one hundred microns (100 μm)) surface topography features configured to enhance the hydrophobicity of the surfaces and structures.

### BRIEF SUMMARY OF THE INVENTION

In some embodiments, the present invention includes methods of forming hydrophobic surfaces or structures in which droplets of metal material are sprayed onto a surface of a substrate comprising a plurality of features (e.g., protrusions, recesses, etc.). The features may be laterally isolated from one another, and may have an average feature width of less than about one hundred microns (100 μm). The plurality of features may be at least partially coated with a metal layer formed from the droplets of metal material.

In additional embodiments, the present invention includes methods of forming a fuel or electrolytic cell in which a plurality of laterally isolated features (e.g., protrusions, recesses, etc.) are formed in at least a portion of a surface of a conductive plate within at least one channel, and at least a portion of the surface of the at least one plate within the at least one channel is configured to be super-hydrophobic.

In additional embodiments, the present invention includes methods of forming a fuel or electrolytic cell in which a substrate is formed that has a surface comprising at least one channel therein, and a plurality of features (e.g., protrusions, recesses, etc.) is formed on or in a surface of the substrate within the at least one channel. Droplets of metal material are sprayed onto the surface of the substrate, and the protrusions are at least partially coated with a metal layer formed from the droplets of metal material. A mold or die may be formed that comprises the metal layer, and the mold or die may be used to form a body of a fuel or electrolytic cell.

In additional embodiments, the present invention includes super-hydrophobic structures comprising a layer of metal material formed from a Rapid Solidification Process (RSP) having a super-hydrophobic exterior surface. The super-hydrophobic exterior surface of the metal material includes a plurality of protrusions having an average protrusion width of less than about one hundred microns (100 μm).

In additional embodiments, the present invention includes fuel or electrolytic cells that include at least one plate comprising a conductive material and having at least one channel formed therein. At least a portion of a surface of the plate within the channel is super-hydrophobic and includes a plurality of features (e.g., protrusions, recesses, etc.) having an average feature width of less than about one hundred microns (100 μm).

In yet other embodiments, the present invention includes fuel or electrolytic cells that include at least one electrically conductive plate comprising a metal material formed from a Rapid Solidification Process (RSP). A surface of the metal material defines at least one channel in the electrically conductive plate.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be more readily ascertained from the following description of the invention when read in conjunction with the accompanying drawings in which:

FIG. 1 is a schematic diagram of a fuel cell illustrating basic principles of operation thereof;

FIG. 2A is a simplified plan view of an embodiment of a conductive electrode structure that includes one or more super-hydrophobic surfaces in accordance with the present invention and that may be used in a fuel cell device;

FIG. 2B is a cross-sectional view of the conductive electrode structure shown in FIG. 2A taken along section line 2B-2B shown therein;

FIG. 2C is an enlarged view of the portion of FIG. 2B enclosed within the dashed circle 2C as shown in FIG. 2B;

FIG. 2D is a yet further enlarged view of the portion of FIG. 2C enclosed within the dashed circle 2D shown in FIG. 2C;

FIG. 3 is a simplified cross-sectional view of a portion of a polymer electrolyte membrane (PEM) fuel cell that includes the electrically conductive electrode structure shown in FIGS. 2A-2D, in accordance with an embodiment of the present invention;

FIG. 4 is a simplified cross-sectional view of an embodiment of a substrate or tool pattern that may be used to fabricate an electrically conductive electrode structure as shown in FIGS. 2A-2D in accordance with an embodiment of the present invention;

FIG. 5 is a simplified schematic view illustrating a rapid solidification process system that may be used to form a conductive electrode structure as shown in FIGS. 2A-2D using a substrate such as that shown in FIG. 4 in accordance with an embodiment of the present invention; and

FIG. 6 is a simplified cross-sectional view of a structure that includes an electrically conductive electrode structure like that shown in FIGS. 2A-2D formed on a substrate as shown in FIG. 4 using the RSP system shown in FIG. 5 in accordance with an embodiment of the present invention.

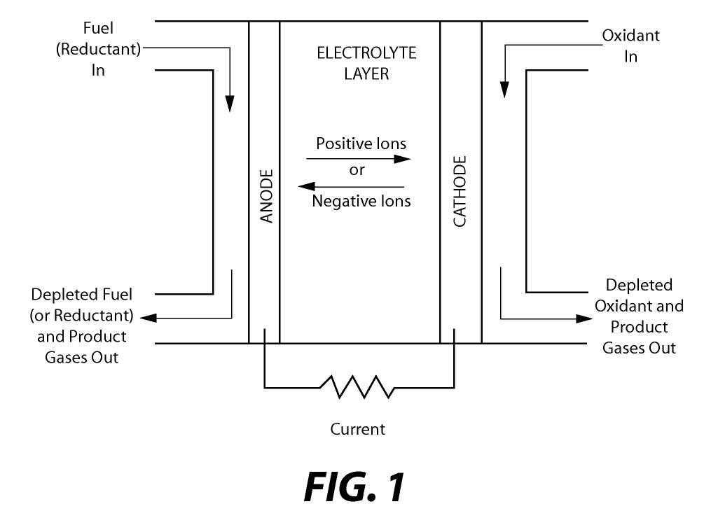

### DETAILED DESCRIPTION OF THE INVENTION

The illustrations presented herein are not meant to be actual views of any particular structure, device, or system, but are merely idealized representations that are employed to describe various embodiments of the present invention. It is noted that elements that are common between figures may retain the same numerical designation.

As used herein, the term “RSP material” means and includes any material formed by the Rapid Solidification Process (RSP), and “RSP metal material” means and includes any metal material formed by a Rapid Solidification Process (RSP).

As used herein, the term “Rapid Solidification Process” means and includes any process in which droplets of a material, such as a metal, a polymer, or a composite, are caused to be atomized and entrained within a jet of gaseous material being directed onto a substrate on which the droplets, after undergoing at least some degree of cooling, meld with one another to form a substantially dense mass of material. In some cases, the droplets may have an average diameter of less than about one hundred microns (100 μm), less than about fifty microns (50 μm), or even less than about ten microns (10 μm).

As used herein, the term “super-hydrophobic surface” means and includes any surface that exhibits a contact angle of greater than about one hundred and thirty-five degrees) (135° when measured in accordance with ASTM Test Method D7334-08.

It was unexpectedly discovered by the inventors of the present invention during development of Rapid Solidification Processes and RSP systems for the production of molds and dies, which did not themselves include surface topographies having any fine-scale (e.g., less than about one hundred microns (100 μm)) features, that fine-scale surface topography features could be transferred from a substrate to an RSP material formed thereover using Rapid Solidification Processes and RSP systems. For example, it was not expected that a fingerprint on the surface of a substrate would result in the formation of a complementary fingerprint pattern on the mating or adjacent surface of an RSP material deposited over that surface of the substrate using a Rapid Solidification Process and an RSP system, when in fact the inventors of the present invention unexpectedly and surprisingly discovered that such was the case. This high-fidelity pattern transfer aspect of Rapid Solidification Processes was not foreseen by the inventors of the present invention. These unexpected and surprising results led the inventors of the present invention to the conception of the many embodiments of the present invention.

Embodiments of the present invention include structures comprising an RSP material. A surface of the RSP material may be textured to be hydrophobic, or to be the image or negative of a hydrophobic surface, as described in further detail below. In some embodiments, the surface of the RSP material may be textured to be super-hydrophobic, or to be the image or negative of a super-hydrophobic surface. The material composition of the RSP material may be selected to enhance the hydrophobicity of the RSP material. In addition or as an alternative, the surface topography of the RSP material may be textured or patterned to enhance the hydrophobicity of the surface of the RSP material.

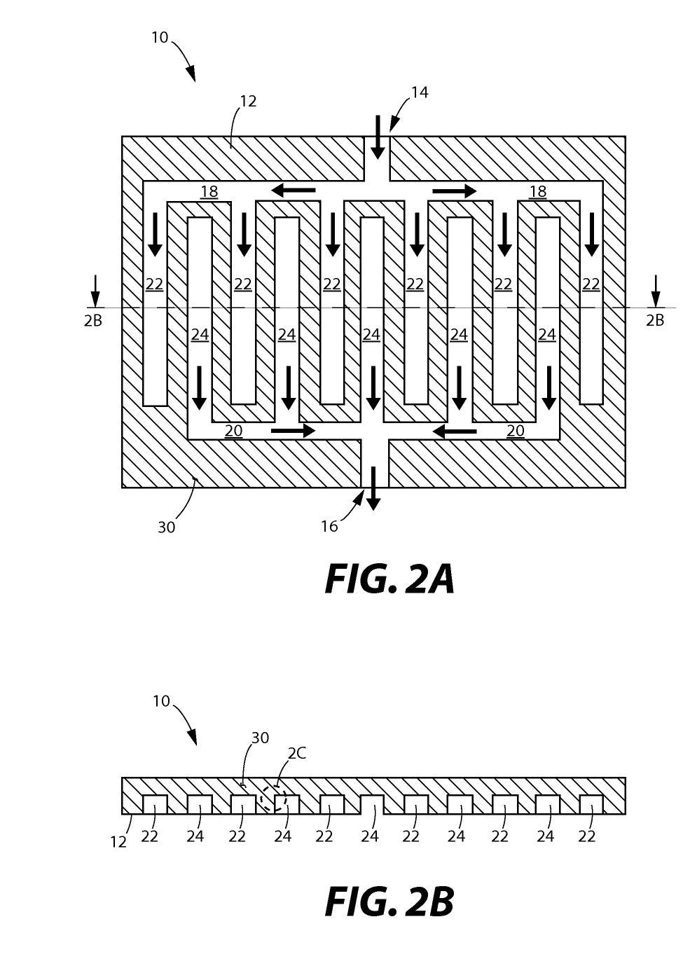

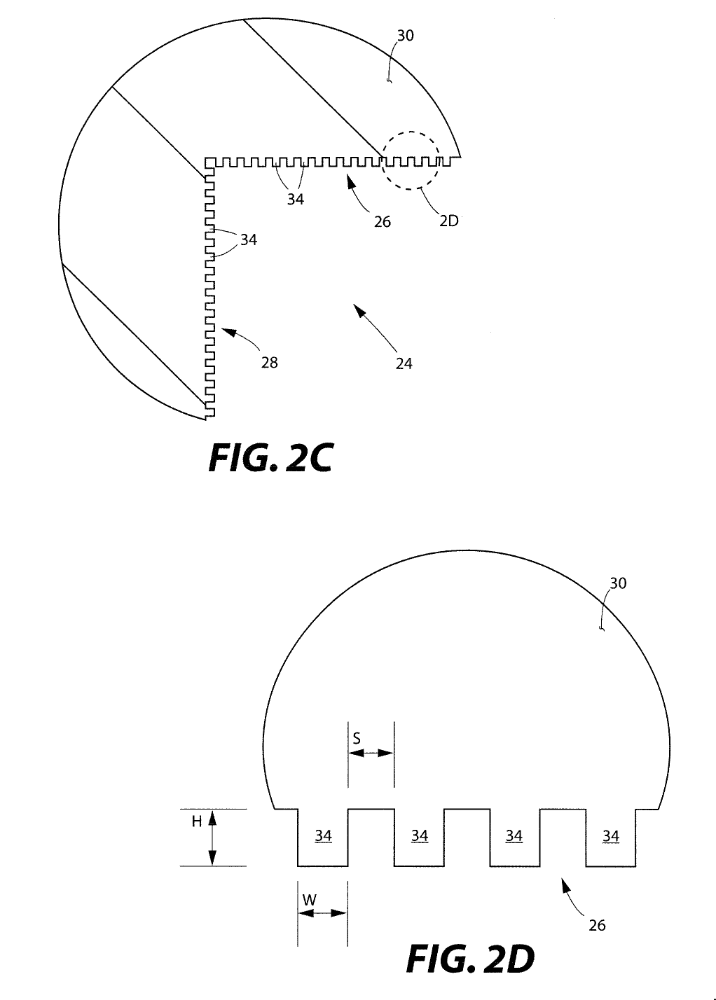

FIGS. 2A-2D are simplified illustrations showing an embodiment of a structure having hydrophobic surfaces in accordance with the present invention. While the present invention may be embodied in any structure having one or more hydrophobic surfaces, the particular structure shown in FIGS. 2A-2D, which embodies the present invention, is an electrically conductive electrode 10 for use in a fuel cell, such as a polymer electrolyte membrane (PEM) fuel cell. It is understood that the conductive electrode 10 is merely used as a non-limiting example of a structure according to one embodiment of the present invention, and that many structures and devices other than conductive electrodes for fuel cells may also be fabricated in accordance with other embodiments of the present invention.

The conductive electrode 10 may be generally planar. FIG. 2A is a plan view of one side of the electrically conductive electrode 10, and FIG. 2B is a cross-sectional view of the electrode 10 taken along section line 2B-2B shown in FIG. 2A. As shown in FIG. 2A, the conductive electrode 10 may include a plurality of recesses which, in the illustrated embodiment, may be characterized as channels, that extend into the body of electrode 10 from a first major surface 12 thereof. While FIG. 2A is not a cross-sectional view, the first major surface 12 has been cross-hatched to more clearly illustrate the channels that extend into the electrode 10 from the first major surface 12. The channels may, optionally, include a plurality of inter-digitated inflow channels 22 and outflow channels 24. The electrode 10 may comprise a fluid inlet 14 and a fluid outlet 16. Fluid communication may be provided between the fluid inlet 14 and each of the inflow channels 22 by a supply channel 18, and fluid communication may be provided between each of the outflow channels 24 and the fluid outlet 16 by a fluid collection channel 20. In this configuration, one or more fluids, such as gases, liquids, vapors, or mixtures thereof, may be caused to flow through the conductive electrode 10 from the inlet 14 through the supply channel 18 to the inflow channels 22, and from the outflow channels 24 into the collection channel 20 out from the outlet 16. Furthermore, fluids may be caused to flow from the inflow channels 22 to the outflow channels 24 as discussed in further detail below with reference to FIG. 2B.

The configuration of the channels shown in FIGS. 2A and 2B is merely a non-limiting example of a channel pattern that may be used in the electrode 10, and many other patterns of flow channels also may be used in embodiments of conductive electrodes of the present invention. For example, the electrode 10 may simply comprise a plurality of continuous channels extending across the surface 12. Furthermore, although the electrode 10 shown in FIGS. 2A and 2B includes channels on only one side thereof, it is understood that the electrode 10 could include channels on both sides thereof. Electrodes having channels on both sides thereof are often used as bipolar electrode plates in stacks of multiple individual fuel cells. In other words, the channels on one side of an electrode plate may be used to supply fuel to an anode of one fuel cell, while channels on the opposite side of the electrode plate may be used to supply oxidant to a cathode of another fuel cell. Such bipolar electrode plates also may embody the present invention.

The conductive electrode 10 may include, or be formed from, an RSP material 30 having one or more surfaces that are hydrophobic (e.g., super-hydrophobic), as discussed in further detail below with reference to FIGS. 2C and 2D. By way of example and not limitation, the RSP material 30 may comprise, for example, an RSP metal material such as an iron-based alloy. For example, the RSP metal material 30 may comprise an austenitic stainless steel such as a grade 310 or a grade 904L stainless steel. In additional embodiments, the RSP material 30 may comprise a nonmetallic material such as a conductive polymer, graphite, a composite of graphite and an epoxy or other polymer, or another electrically conductive material that is inert in the operating environment of a fuel cell or electrolytic cell.

FIG. 2C is an enlarged view of the portion of the FIG. 2B enclosed within the dashed circular line 2C shown in FIG. 2B and illustrates a portion of an outflow channel 24. Each of the inflow channels 22 and outflow channels 24 may be partially bounded by an adjacent back surface 26 and adjacent lateral sidewall surfaces 28 that extend from the back surface 26 to the first major surface 12 of the electrode 10 (FIGS. 2A and 2B). In some embodiments of the present invention, one or more of the surfaces 26, 28 adjacent to the inflow channels 22, the outflow channels 24, the supply channel 18, and/or the collection channel 20 may have a topography configured to enhance the hydrophobicity of those surfaces 26, 28. In other words, one or more of the surfaces 26, 28 may be textured or patterned to enhance the hydrophobicity of those surfaces 26, 28. In some embodiments, one or more of the surfaces 26, 28 may have a surface pattern or texture configured to render the surfaces 26, 28 super-hydrophobic.

Although both the back surface 26 and the sidewall surface 28 are shown in FIG. 2C to be textured or patterned, in additional embodiments of the present invention, only the back surface 26 of one or more of the channels may be textured or patterned, or only the sidewall surfaces 28 of one or more of the channels may be textured or patterned. Furthermore, it is understood that, although the channels shown in FIGS. 2A-2D have a rectangular cross-sectional shape, other embodiments of conductive electrodes of the present invention may have channels having other cross-sectional shapes (e.g., semi-circular, semi-oval, semi-elliptical, V-shaped, U-shaped, etc.) and any one or more surfaces of the RSP metal material 30 within such channels may be textured or patterned to enhance the hydrophobicity of the surfaces and, optionally, render the surfaces super-hydrophobic in accordance with embodiments of the present invention.

By way of example and not limitation, one or more of the surfaces 26, 28 of the RSP material 30 adjacent to the channels of the electrode 10 may comprise a plurality of protrusions 34. The protrusions 34 may comprise, for example, pillars, posts, columns, or cones. In other embodiments, the protrusions 34 may be elongated ribs extending along linear or nonlinear paths, or both, across one or more of the surfaces 26, 28 of the RSP metal material 30 within the channels of the electrode 10. The protrusions 34 may be substantially laterally isolated from one another, such that at least a majority of the protrusions 34 do not contact any adjacent protrusions 34.

In some embodiments, the protrusions 34 may be disposed at random locations across the surfaces 26, 28 of the RSP material 30 within the channels. In additional embodiments, the protrusions 34 may be disposed at selected locations across the surfaces 26, 28 of the RSP metal material 30. Furthermore, the protrusions 34 may be disposed in an ordered array across the surfaces 26, 28 of the RSP metal material 30 within the channels. For example, the protrusions 34 may comprise a plurality of posts disposed in an ordered array comprising a plurality of rows and columns across the surfaces 26, 28 of the RSP metal material 30 within the channels of the electrode 10.

FIG. 2D is an enlarged view of the portion of FIG. 2C enclosed within the dashed circle 2D shown in FIG. 2C. As a non-limiting example, the plurality of laterally isolated protrusions 34 may comprise a plurality of laterally isolated pillars, posts, columns, or cones having an average protrusion width W of less than about one hundred microns (100 μm), an average protrusion height H of less than about three hundred microns (300 μm), and an average inter-protrusion spacing S of less than about one hundred microns (100 μm). More particularly, the plurality of laterally isolated protrusions 34 may comprise a plurality of laterally isolated pillars, posts, columns, or cones having an average protrusion width W of between about five microns (5 μm) and about seventy microns (70 μm), an average height H of between about ten microns (10 μm) and about three hundred microns (300 μm), and an average inter-protrusion spacing S of between about ten microns (10 μm) and about one hundred microns (100 μm).

It is known that the surfaces of certain plants and other organic matter are hydrophobic, and even super-hydrophobic. For example, it is known that the leaves of certain plants such as, for example, nelumbo nucifera, colocasia esculenta, and nasturtium are hydrophobic. In some embodiments of the present invention, structures or devices may be fabricated that include hydrophobic or super-hydrophobic surfaces having a surface topography derived from, patterned after, or at least substantially identical to, the surface topography of plant matter such as, for example, the leaves of one or more of nelumbo nucifera, colocasia esculenta, and nasturtium. For example, in some embodiments of the present invention, one or more of the surfaces 26, 28 of the RSP metal material 30 within the channels of the electrode 10 may comprise a surface topography that is derived from, patterned after, or at least substantially identical to, the surface topography of one or more of such plants.

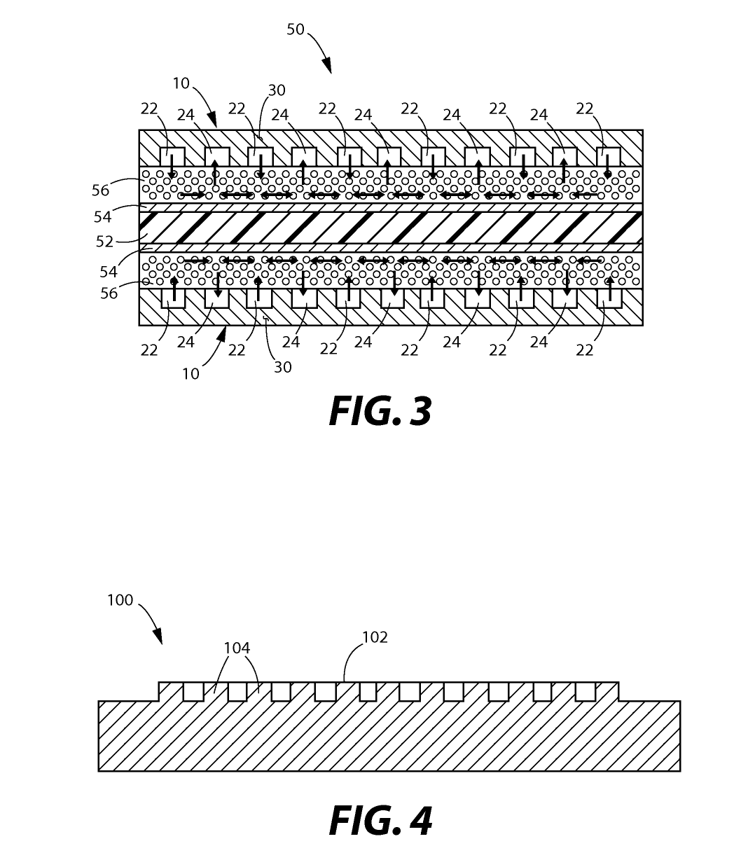

Embodiments of conductive electrodes of the present invention may be used in embodiments of fuel cells of the present invention. For example, FIG. 3 is a simplified cross-sectional view of a portion of an embodiment of a polymer electrolyte membrane (PEM) fuel cell 50 of the present invention. The PEM fuel cell 50 includes a polymer electrolyte membrane 52 and a catalyst layer 54 on at least one side of and in direct contact with the polymer electrolyte membrane 52. The PEM fuel cell 50 optionally may include a gas diffusion layer 56 on a side of the catalyst layer 54 opposite the polymer electrolyte membrane 52. The PEM fuel cell 50 also includes at least one conductive electrode 10 as previously described herein with reference to FIGS. 2A-2D. For example, a conductive electrode 10 may be disposed adjacent a gas diffusion layer 56 on a side thereof opposite the catalyst layer 54, as shown in FIG. 3. In some embodiments of the present invention, the PEM fuel cell 50 may include two or more conductive electrodes 10.

Materials that may be used for the polymer electrolyte membrane 52 are known in the art and include, for example, sulfonated polymers such as those sold by E. I. Du Pont Nemours and Company of Wilmington, Del. under the trademark NAFION®. The catalyst layer 54 may comprise a layer of platinum. The gas diffusion layer 56 may comprise a porous ceramic, polymer, or metal material.

The directional arrows shown in FIG. 3 generally illustrate the flow of gases through the gas diffusion layer 56 during operation of the fuel cell 50. As depicted, gas may flow from the inflow channels 22 in the conductive electrode 10 through the gas diffusion layer 56 to the catalyst layer 54 where one or more chemical reactions may occur. Unused reactant gas and product gases of the one or more chemical reactions may flow from the catalyst layer 54 through the gas diffusion layer 56 to the outflow channels 24.

As previously mentioned herein, water may be a product of one or more reactions occurring within the PEM fuel cell 50, and such water may accumulate in and pass through the inflow channels 22 and/or the outflow channels 24. By texturing or patterning one or more of the surfaces 26, 28 of the supply channel 18, the collection channel 20, the inflow channels 22, and the outflow channels 24 of the conductive electrode 10 (see FIGS. 2A-2D) to enhance the hydrophobicity of the surfaces 26, 28, and, optionally, to render the surfaces 26, 28 super-hydrophobic, the flow of water and/or other liquids through the various flow channels of the conductive electrode 10 may be enhanced. As a result, the performance of embodiments of fuel cells of the present invention may be enhanced relative to previously known fuel cells.

Examples of methods according to the present invention that may be used to fabricate a structure having one or more hydrophobic surfaces, such as the conductive electrode 10 shown in FIGS. 2A-2D, are described below with reference to FIGS. 4-6.

Broadly, an RSP metal material 30 may be applied to a substrate using a Rapid Solidification Process. At least one of the composition of the RSP metal material 30 and the topography of a surface of the substrate may be configured to enhance the hydrophobicity of the resulting structure, and, optionally, to render a surface of the resulting structure super-hydrophobic. The RSP metal material 30 may be applied to the substrate by, for example, using the systems and methods disclosed in U.S. Pat. No. 5,445,324 to Berry et al., which issued Aug. 29, 1995 and is entitled Pressurized Feed-Injection Spray-Forming Apparatus, U.S. Pat. No. 5,718,863 to McHugh et al., which issued Feb. 17, 1998 and is entitled Spray Forming Process for Producing Molds, Dies and Related Tooling, and U.S. Pat. No. 6,746,225 to McHugh, which issued Jun. 8, 2004 and is entitled Rapid Solidification Processing System for Producing Molds, Dies and Related Tooling, the entire disclosure of each of which patents is incorporated herein in its entirety by this reference. For example, droplets of solidifying metal material may be sprayed onto a substrate having a surface comprising a plurality of protrusions. The protrusions may be laterally isolated from one another and, in some embodiments, may be configured to render the surface super-hydrophobic. For example, in some embodiments, the protrusions may have an average protrusion width of less than about one hundred microns (100 μm), as previously described herein. As the droplets of metal material are sprayed onto the substrate, the plurality of protrusions may be at least partially coated with a metal layer comprising an RSP metal material formed from the droplets of solidifying metal material. Such methods may be used to form a wide variety of hydrophobic and super-hydrophobic structures and devices, and are described in further detail below with reference to FIGS. 4 through 6 using the formation of a conductive electrode 10 for a fuel or electrolytic cell as a non-limiting example of a structure that may be formed in accordance with the present invention.

Referring to FIG. 4, a substrate 100, such as a mold or die, may be provided and used as a substrate to which an RSP metal material 30 may be applied to form a structure such as the conductive electrode 10 previously described with reference to FIGS. 2A-2D. The substrate 100 includes at least one surface 102 that may be used to form a hydrophobic and, optionally, super-hydrophobic, surface of a structure to be fabricated using the substrate 100. More particularly, the surface 102 of the substrate 100 may have a topography that is a mirror image or a negative of a surface of a hydrophobic structure that is to be fabricated using the substrate 100. By way of example and not limitation, the surface 102 of the substrate 100 may have a topography that is a mirror image or a negative of the surfaces of the conductive electrode 10 on the side thereof shown adjacent the gas diffusion layer 56 in FIG. 3. The surface 102 of the substrate 100 may comprise a plurality of ridges 104 having sizes, shapes, and surface topographies configured to form the supply channel 18, the collection channel 20, the inflow channels 22, and the outflow channels 24 of the conductive electrode 10 (see FIGS. 2A-2D). Although not visible in FIG. 4, areas of the surface 102 of the substrate 100 on one or more of the ridges 104 may having a fine surface topography that is complementary to the corresponding fine surface topography of the conductive electrode 10 to be formed. In other words, areas of the surface 102 of the substrate 100 on one or more of the ridges 104 may have a fine surface topography that is a mirror image or a negative of that previously described with reference to FIGS. 2C and 2D.

The substrate 100 may be fabricated from any material that is physically and chemically stable throughout the temperature range to which the substrate 100 will be subjected as a conductive electrode 10 or other structure having a hydrophobic surface is fabricated using the substrate 100, and that can be separated or removed from the conductive electrode 10 or other structure formed thereon, as described below. For example, the substrate 100 may comprise a ceramic material such as, for example, an oxide material (e.g., aluminum oxide (Al₂O₃)), a nonmetal such as silicon or graphite, a nitride material (e.g., boron nitride (BN)), or a carbide (e.g., silicon carbide (SiC)). In additional embodiments, the substrate 100 may comprise a polymeric material such as polyethylene, or a thermoset resin such as an epoxy, or an elastomeric rubber material (e.g., silicon rubber).

The substrate 100 may be fabricated by many different processes. For example, the substrate 100 may be fabricated by shaping the substrate from a piece of stock material. Conventional mechanical machining processes, wet chemical etching methods, laser machining processes and lithography processes (e.g., masking and etching processes or particle beam lithography processes such as molecular beam lithography, ion beam lithography, or electron beam lithography) may be used to form a substrate 100 directly from a piece of stock material. In embodiments in which a surface of a conductive electrode 10 is to include very small topographic features for rendering the surface hydrophobic, it may not be feasible to form the corresponding surface 102 of the substrate 100 using conventional mechanical machining processes. In such embodiments, laser machining processes, etching, and lithography processes may be used to form the surface 102 of the substrate 100.

In additional embodiments, the substrate 100 may be fabricated by molding or casting (e.g., slip casting and vacuum casting) the substrate 100 in a mold or die (not shown) that is directly fabricated using methods such as those set forth above. In particular, the substrate 100 may be fabricated from epoxy, polyurethane, and silicon rubber materials in molds made of silicon, poly(methyl)methacrylate (PMMA), and other materials. Such molds may be fabricated using laser machining processes, etching processes, and lithography processes.

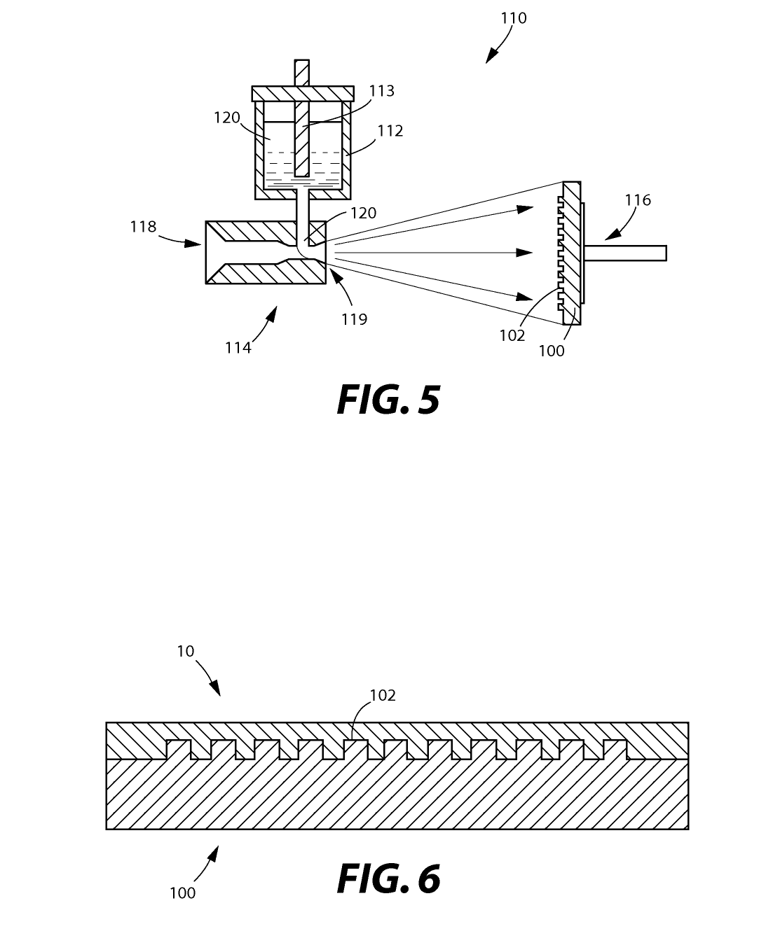

After forming or otherwise providing the substrate 100, a Rapid Solidification Process (RSP) may be used to apply an RSP metal material 30 to the surface 102 of the substrate 100 to form the conductive electrode 10 or other structure thereon. Referring to FIG. 5, an RSP system 110 may be used to carry out such a Rapid Solidification Process. The RSP system 110 may include, for example, a crucible 112, which may be capable of being pressurized, a nozzle 114 in fluid communication with an interior of the crucible 112, and a substrate manipulator 116. The RSP system 110 also may include one or more heating devices or systems (not shown) for heating the crucible 112 to a temperature sufficient to melt metal material 120 contained therein. The metal material 120 may be used to ultimately form the RSP metal material 30 after the metal material 120 has been sprayed onto the substrate 100 as described in further detail below. The nozzle 114 also may be heated during use of the RSP system 110. The RSP system 110 may further include a source of pressurized inert gas (not shown) such as, for example, nitrogen or argon.

The substrate 100 may be mounted on a substrate manipulator 116 capable of moving the substrate 100 relative to a nozzle 112 and a flow of material being sprayed from the nozzle 112 onto the surface 102 of the substrate 100. For example, the substrate manipulator 116 may be capable of rotating the substrate 100 about one or more axes of rotation, and may be capable of translating the substrate 100 in one, two, or three spatial dimensions (i.e., X, Y, and Z directions) relative to the nozzle 112 and the flow of material being sprayed therefrom onto the surface 102 of the substrate 100. As one non-limiting example, the substrate manipulator 116 may comprise, for example, a support platen (for supporting the substrate 100 thereon) mounted to a robotic arm.

To apply the RSP metal material 30 (FIGS. 2A-2D) to the substrate 100 and form the conductive electrode 10 (FIGS. 2A and 2B) or other structure, the metal material 120 within the crucible 112 may be heated to a temperature sufficient to melt the metal material 120. A stream of the inert gas supplied by the previously mentioned inert gas source may be forced through the nozzle 114 along a flow path extending from an inlet 118 of the nozzle 114 to an outlet 119 of the nozzle 114. As the inert gas flows through the nozzle 114 at relatively high velocity, molten metal material 120 may be caused to flow from the crucible 112 into the nozzle 114 and into the flow path of the inert gas passing through the nozzle 114, as shown in FIG. 5. By way of example and not limitation, a stopper rod 113 may be used to start and stop the flow of molten metal material 120 from the crucible 112 into the nozzle 114. As the inert gas flows through the nozzle 114 and mixes with the molten metal material 120, the jet of inert gas causes the molten metal material 120 to break up into a stream of extremely small droplets of metal material 120 that become entrained within the jet of inert gas and are directed onto the surface 102 of the substrate 100.

As the droplets of metal material 120 traverse the distance between the outlet 119 of the nozzle 114 and the surface 102 of the substrate 100, they cool at very high rates (e.g., about 10⁵ degrees Kelvin per second) that depend on spray conditions, the size of the droplets of metal material 120, and their trajectory onto the substrate 100. As a result, the droplets of metal material 120 may be solidifying at a rapid rate as they are sprayed toward and directed onto the substrate 100. As a result, a combination of liquid droplets, solid droplets, and partially liquid and partially solid droplets may impact the substrate 100. As the droplets of solidifying metal material 120 impact the substrate 100, they meld together with one another to form a substantially dense RSP metal material 30 on the surface 102 of the substrate 100. For example, the RSP metal material 30 deposited on the surface 102 of the substrate 100 may have a density of greater than about ninety-three percent (93%), and may be more than about ninety-nine percent (99%) of the theoretical density of the RSP metal material 30.

RSP systems and methods suitable for carrying out methods of the present invention are described in further detail in the aforementioned U.S. Pat. Nos. 5,445,324 to Berry et al., 5,718,863 to McHugh et al., and U.S. Pat. No. 6,746,225 to McHugh.

FIG. 6 illustrates a structure that comprises a conductive electrode 10 formed from an RSP material 30 that has been deposited onto the surface 102 of the substrate 100 using a Rapid Solidification Process such as that described above with reference to FIG. 5. After depositing the RSP material 30 onto the substrate 100, the lateral surfaces of the resulting structure may be machined using, for example, a wire electric discharge machine (EDM) to smoothen the lateral surfaces of the conductive electrode 10 and to bring the dimensions of the conductive electrode 10 to within desirable tolerances.

After forming the conductive electrode 10 or other structure on the substrate 100, the conductive electrode 10 and the substrate 100 may be separated from one another. In embodiments in which the substrate 100 comprises a ceramic material, it may be possible to break or fracture the substrate 100 using mechanical forces in such a way as to remove the substrate 100 from the conductive electrode 10 without damaging the conductive electrode 10 in any significant manner. In other embodiments, the substrate 100 may be removed using a chemical solvent or an etchant that will dissolve or etch away the substrate 100 at a rate significantly higher than a rate at which the solvent or etchant will dissolve or etch away the conductive electrode 10.

As previously mentioned, in some embodiments of the present invention, structures or devices may be fabricated that include hydrophobic or super-hydrophobic surfaces having a surface topography derived from, patterned after, or substantially identical to, the surface topography of plant matter such as, for example, the leaves of one or more of nelumbo nucifera, colocasia esculenta, and nasturtium. For example, in some embodiments of the present invention, one or more of the surfaces 26, 28 of the RSP metal material 30 within the channels of the electrode 10 may comprise a surface topography that is derived from, patterned after, or at least substantially identical to, the surface topography of one or more of such plants.

For example, referring again to FIG. 4, one or more of the surfaces 102 of the substrate 100 on the ridges 104 may be formed to comprise a surface topography that is derived from, patterned after, or at least substantially identical to, the surface topography of the surface of hydrophobic or super-hydrophobic plant matter. To form such a substrate 100, the substrate 100 may be cast within another mold or die. Prior to casting the substrate 100 in the mold or die, however, the plant matter may be positioned within the mold or die at a location such that the hydrophobic or super-hydrophobic surfaces of the plant matter will be disposed at locations within the mold or die corresponding to the surfaces of the ridges 104. As a result, when the substrate 100 is cast within the mold or die, the surfaces 102 of the substrate 100 on the ridges 104 may contain a surface topography that is derived from and at least substantially identical to the surface topography of the plant matter previously placed within the mold or die prior to casting the substrate 100 therein.

In additional embodiments, it may be possible to simply adhere plant matter to the ridges 104 of the substrate 100 prior to depositing RSP metal material 30 thereover such that the surfaces adjacent to the channels of the resulting electrode 10 formed on the substrate 100 have a surface topography that is derived from and at least substantially identical to the surface topography of the plant matter previously placed over the ridges 104 of the substrate 100.

In additional embodiments of the present invention, an RSP process may be used to form a mold or die comprising an RSP material, and the mold or die then may be used to form an end structure comprising a hydrophobic surface (e.g., a super-hydrophobic surface) using, for example, a molding, stamping, or punching process. In other words, the process used to form the electrode 10 described hereinabove with reference to FIGS. 4 through 6 instead may be used to form a mold or die having a textured surface that is the negative (i.e., inverse) of a hydrophobic (e.g., super-hydrophobic) surface to be formed using the mold or die. The resulting mold or die then may be used to form a structure having a hydrophobic surface using other methods such as, for example, a molding, stamping, or punching process. In such embodiments, the end structure comprising the hydrophobic surface may not comprise an RSP material, although the mold or die used to form the end structure would comprise an RSP material.

As will be appreciated from the description set forth herein above, the present invention provides a novel method of fabricating hydrophobic and super-hydrophobic surfaces and structures. By using a Rapid Solidification Process to apply RSP material to a substrate having a fine surface topography, the fine surface topography may be formed in the surface of the RSP material of the resulting structure, and the fine surface topography may be configured to impart hydrophobicity, and, optionally, super-hydrophobicity, to the surface of the RSP material. Such methods are more versatile relative to previously known methods in that they enable the formation of relatively finer or smaller features in the hydrophobic structure being formed. Furthermore, such methods may be relatively cheaper than many previously known methods for forming hydrophobic and super-hydrophobic surfaces and structures, and may be relatively more suitable for use in high-volume manufacturing processes relative to previously known methods.

While embodiments of the invention have been described herein with reference to a fuel cell and conductive electrodes therefore, embodiments of the present invention also may include electrolytic cells and conductive electrodes of electrolytic cells. For example, embodiments of electrolytic cells of the present invention may include one or more conductive electrodes 10 as previously described herein with reference to FIGS. 2A-2D.

Furthermore, various other structures according to embodiments of the present invention may be fabricated to comprise super-hydrophobic surfaces in accordance with methods of the present invention as previously described herein. Any structure in which it is desirable to render one or more surfaces thereof repellent to water or another polar liquid may embody the present invention. The performance of many structures and devices may be improved by enhancing the hydrophobicity of one or more surfaces thereof. For example, when a polar liquid flows over a surface of a structure or device during use, the resistance to the flow of the liquid may be reduced by enhancing the hydrophobicity of the surfaces. Surfaces may be rendered to be relatively more easily to clean or even to be self-cleaning (if the surfaces are periodically exposed to water or other polar fluids during use) by enhancing the hydrophobicity of the surfaces. Furthermore, surfaces that corrode when exposed to water or other polar liquids may be caused, by implementation of embodiments of the present invention, to exhibit relatively slower corrosion rates by enhancing the hydrophobicity of the surfaces. In view of the above, dropwise condenser surfaces to enhance condensation heat transfer, fluid conduits for the flow of liquid therethrough, body panels for cars and other vehicles, boat hulls, cookware (e.g., pots and pans) all may be formed to include hydrophobic, and, optionally, super-hydrophobic surfaces, using embodiments of methods of the present invention as previously described herein. Furthermore, such hydrophobic and super-hydrophobic structures may be formed from and comprise any type of RSP material, or they may be formed using a mold or die comprising an RSP material, the mold or die having been formed from an RSP process.

While the invention is susceptible to various modifications and implementation in alternative forms, specific embodiments have been shown by way of non-limiting example in the drawings and have been described in detail herein. However, it should be understood that the invention is not intended to be limited to the particular forms disclosed. Rather, the invention includes all modifications, equivalents, and alternatives falling within the scope of the invention as defined by the following appended claims and their legal equivalents.

1. A method of forming a super-hydrophobic surface or structure, comprising:
forming a substrate having a surface comprising a plurality of laterally isolated features having an average feature width of less than about one hundred microns (100 μm);
spraying droplets of metal material toward the surface of the substrate to coat at least portions of the plurality of laterally isolated features with a metal layer formed by droplets of the metal material solidified thereon.

2. The method of claim 1, further comprising forming the plurality of laterally isolated features to have an average feature width of between about five microns (5 μm) and about seventy microns (70 μm).

3. The method of claim 2, further comprising forming the plurality of laterally isolated features to have an average feature height of between about ten microns (10 μm) and about three hundred three hundred microns (300 μm).

4. The method of claim 3, further comprising forming the plurality of laterally isolated features to have an average inter-feature spacing of between about ten microns (10 μm) and about one hundred one hundred microns (100 μm).

5. The method of claim 1, wherein coating at least portions of the plurality of laterally isolated features with a metal layer comprises coating at least portions of the plurality of laterally isolated features with a layer of steel.

6. The method of claim 1, further comprising forming the plurality of laterally isolated features to comprise a plurality of protrusions.

7. The method of claim 6, wherein spraying the droplets of the metal material toward the surface of the substrate comprises forming a mold or die comprising the metal layer.

8. The method of claim 7, further comprising using the mold or die to form the super-hydrophobic surface or structure.

9. The method of claim 1, further comprising forming the plurality of laterally isolated features to comprise a plurality of recesses.

10. The method of claim 9, further comprising forming the super-hydrophobic surface or structure to comprise the metal layer.

11. A method of forming a fuel or electrolytic cell, comprising:
forming at least one channel in a surface of at least one conductive plate;
forming a plurality of laterally isolated features in at least a portion of the surface of the at least one conductive plate within the at least one channel; and
configuring at least a portion of the surface of the at least one conductive plate within the at least one channel to be super-hydrophobic.

12. The method of claim 11, further comprising forming the plurality of laterally isolated features to have an average feature width of less than about one hundred microns (100 μm).

13. The method of claim 12, further comprising forming the plurality of laterally isolated features to comprise a plurality of laterally isolated protrusions.

14. A method of forming a fuel or electrolytic cell, comprising:
forming a substrate having a surface comprising at least one channel therein,
forming a plurality of laterally isolated features in or on a surface of the substrate within the at least one channel;
projecting droplets of metal material toward the surface of the substrate;
at least partially coating the plurality of laterally isolated features with a metal layer formed from solidified droplets of the metal material to form a mold or die comprising the metal layer; and
using the mold or die to form a body of a fuel or electrolytic cell.

15. The method of claim 14, further comprising forming the plurality of laterally isolated features to have an average recess width of less than about one hundred microns (100 μm).

16. The method of claim 14, further comprising forming the at least one channel to have an average cross-sectional area of between about 0.50 square millimeters (mm²) and about 3.00 square millimeters (mm²).

17. The method of claim 14, further comprising forming the plurality of laterally isolated features to comprise a plurality of laterally isolated protrusions.

18. A super-hydrophobic structure, comprising:
a layer of RSP metal material comprising a super-hydrophobic exterior surface comprising a plurality of laterally isolated protrusions having an average protrusion width of less than about one hundred microns (100 μm).

19. The super-hydrophobic structure of claim 18, wherein the protrusions of the plurality of laterally isolated protrusions have an average protrusion width of between about five microns (5 μm) and about seventy microns (70 μm).

20. The super-hydrophobic structure of claim 19, wherein the protrusions of the plurality of laterally isolated protrusions have an average protrusion height of between about ten microns (10 μm) and about three hundred three hundred microns (300 μm).

21. The super-hydrophobic structure of claim 20, wherein the protrusions of the plurality of laterally isolated protrusions have an average inter-protrusion separation of between about ten microns (10 μm) and about one hundred microns (100 μm).

22. The super-hydrophobic structure of claim 18, wherein the RSP metal material comprises steel.

23. A structure adapted for use as a fuel or electrolytic cell, comprising:
at least one plate comprising a conductive material, the at least one plate having a first major side and an opposing second major side, at least one of the first major side and the opposing second major side having at least one channel formed therein, at least a portion of a surface of the at least one plate adjacent the at least one channel being super-hydrophobic and comprising a plurality of laterally isolated features, the plurality of laterally isolated features having an average feature width of less than about one hundred microns (100 μm).

24. The structure of claim 23, wherein the at least a portion of the surface of the at least one plate within the at least one channel comprises an RSP metal material.

25. The structure of claim 23, wherein the at least one channel has an average cross-sectional area of between about 0.50 square millimeters (mm²) and about 3.00 square millimeters (mm²).

26. The structure of claim 21, wherein the plurality of laterally isolated features comprises a plurality of laterally isolated protrusions.

27. A fuel or electrolytic cell, comprising:
at least one electrically conductive plate having a first major side and an opposing second major side, the at least one electrically conductive plate comprising an RSP metal material, a surface of the RSP metal material defining at least one channel in at least one of the first major side and the opposing second major side of the at least one electrically conductive plate.

28. The fuel or electrolytic cell of claim 27, wherein at least a portion of the surface of the RSP metal material within the at least one channel is super-hydrophobic.

29. The fuel or electrolytic cell of claim 28, wherein the at least a portion of the surface of the RSP metal material comprises a plurality of laterally isolated protrusions.

30. The fuel or electrolytic cell of claim 29, wherein the protrusions of the plurality of laterally isolated protrusions have an average protrusion width of less than about one hundred microns (100 μm).
